(19) United States
(12) Patent Application Publication
(10) Pub. No.: US 2026/0024845 A1
(43) Pub. Date: Jan. 22, 2026

(54) FLEXIBLE BATTERY AND DISPLAY DEVICE HAVING THE SAME

(71) Applicant: LG Display Co., Ltd., Seoul (KR)

(72) Inventor: JaeYoung OH, Goyang-si (KR)

(73) Assignee: LG Display Co., Ltd., Seoul (KR)

(21) Appl. No.: 19/224,461

(22) Filed: May 30, 2025

(30) Foreign Application Priority Data
Jul. 18, 2024 (KR) 10-2024-0095130

(51) Int. Cl. H01M 50/124; H01M 50/105; H01M 50/119; H01M 50/126; H01M 50/136

(52) U.S. Cl. CPC H01M 50/1245; H01M 50/105; H01M 50/119; H01M 50/126; H01M 50/136; H01M 2220/30

(57) ABSTRACT

A flexible battery may include an electrode assembly, a first exterior material and a second exterior material bonded at edges and encapsulate the electrode assembly above and below the electrode assembly, and a multi-layered inorganic film which is deposited on exterior surfaces of the bonded first and second exterior materials, and a thickness of the multi-layered inorganic film on a side surface of the bonded first and second exterior materials is greater than a thickness in the upper portion and the lower portion. Therefore, moisture permeation to the side surface of the flexible battery may be blocked.

### CROSS-REFERENCE TO RELATED APPLICATIONS

This application claims the priority of Korean Patent Application No. 10-2024-0095130 filed on Jul. 18, 2024, in the Korean Intellectual Property Office, the disclosure of which is incorporated herein by reference.

### BACKGROUND

### Technical Field

The present disclosure relates to a flexible battery and a display device having the same, and more particularly, to a flexible battery which improves flexibility with an ultra-thin laminated exterior material and enhances waterproof efficiency of moisture permeation and a display device having the same.

### Discussion of the Related Art

As the demand for mobile electronic devices, such as cell phones, notebooks, and digital cameras continues to increase, a demand for thin energy storage devices is also rapidly increasing.

Among such thin energy storage devices, secondary batteries are used and among the secondary batteries, the use of a lithium secondary battery which operate with a high energy density and high output is increasing.

The secondary battery includes a nickel-cadmium battery, a nickel-metal hydride battery, a nickel-hydrogen battery, and a lithium secondary battery. Specifically, as compared with other secondary batteries, such as a lead storage battery, a nickel cadmium battery, a nickel-hydrogen battery, and a nickel-zinc battery, the lithium secondary battery has a high energy density per unit weight and is rapidly charged to have a high usability.

Among these secondary batteries, the lithium-ion battery which uses a liquid electrolyte is used to be welded and sealed with a metal can as a container. The can-type secondary battery which uses the metal can as a container has a fixed shape so that it limits design of electronic devices and it is difficult to reduce a volume.

Therefore, a pouch type secondary battery in which two electrodes, a separator, and an electrolyte are put into a pouch to be sealed is developed and used.

### SUMMARY

Accordingly, embodiments of the present disclosure are directed to a flexible battery and a display device having the same that substantially obviate one or more of the problems due to limitations and disadvantages of the related art.

An aspect of the present disclosure is to provide a flexible battery which blocks moisture permeation from a side surface and a display device having the same.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concepts, as embodied and broadly described herein, a flexible battery comprises an electrode assembly, a first exterior material and a second exterior material bonded at edges and encapsulate the electrode assembly above and below the electrode assembly, and a multi-layered inorganic film which is deposited on exterior surfaces of the bonded first and second exterior materials, and a thickness of the multi-layered inorganic film on a side surface of the bonded first and second exterior materials is greater than a thickness in the upper portion and the lower portion.

In another aspect, a flexible battery comprises an electrode assembly and a first exterior material and a second exterior material which seal the electrode assembly above and below the electrode assembly and bond one ends at the edge to configure a bonded portion. The first exterior material includes a first inner film, a first barrier layer, and a first outer film, the second exterior material includes a second inner film, a second barrier layer, and a second outer film, and in the bonded portion, one barrier layer configured by the first and second barrier layers may be disposed.

In yet another aspect, a display device may be configured to include the above-described flexible battery.

Other detailed matters of the exemplary embodiments are included in the detailed description and the drawings.

According to the present disclosure, moisture permeation to a side surface of a flexible battery is blocked to increase a lifespan. Therefore, the lifespan of the flexible battery is increased so that a greenhouse gas which may be generated due to a manufacturing process for producing a new flexible battery is reduced to implement environment/social/governance (ESG).

It is to be understood that both the foregoing general description and the following detailed description are exemplary and explanatory and are intended to provide further explanation of the inventive concepts as claimed.

### BRIEF DESCRIPTION OF DRAWINGS

The accompanying drawings, which are included to provide a further understanding of the disclosure and are incorporated in and constitute a part of this application, illustrate embodiments of the disclosure and together with the description serve to explain various principles. In the drawings:

FIGS. 1A and 1B are perspective views illustrating an example of a cell phone;

FIG. 2 is a perspective view illustrating another example of a deformable cell phone;

FIG. 3 is a perspective view illustrating an example of a smart watch;

FIG. 4 is a perspective view illustrating a flexible battery of a first exemplary embodiment of the present disclosure;

FIG. 5 is a view schematically illustrating a cross-section taken along the line I-I′ of FIG. 4;

FIGS. 6A, 6B, and 6C are cross-sectional views illustrating parts A, B, and C of FIG. 5;

FIG. 7 is a cross-sectional view illustrating a method of depositing a multi-layered inorganic film on an edge of a flexible battery of FIG. 5 as an example;

FIGS. 8A and 8B are cross-sectional views illustrating parts D and E of a flexible battery of FIG. 7 in which a multi-layered inorganic film is deposited as an example;

FIG. 9 is a cross-sectional view illustrating a flexible battery of a second exemplary embodiment of the present disclosure;

FIGS. 10A to 10D are cross-sectional views illustrating parts A′, A″, B′, and C′ of FIG. 9, respectively, as an example; and

FIGS. 11A and 11B are cross-sectional views illustrating an edge of a flexible battery according to a third exemplary embodiment of the present disclosure as an example.

### DETAILED DESCRIPTION

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, an exemplary embodiment of the present disclosure will be described in detail with reference to the drawings.

Thin energy storage devices may be used for mobile electronic devices, such as cell phones, smart phones, laptop computers, digital broadcasting terminals, personal digital assistants (PDA), portable multimedia players (PMP), navigations, slate PCs, tablet PCs, ultra-books, or wearable devices of smart watches.

The thin energy storage devices may be used not only for the above-mentioned mobile electronic devices, but also stationary electronic devices, such as digital TVs, desktop computers, or digital signage.

Hereinafter, as an example of a mobile electronic device in which a thin energy storage device is used, a cell phone and a smart watch will be described.

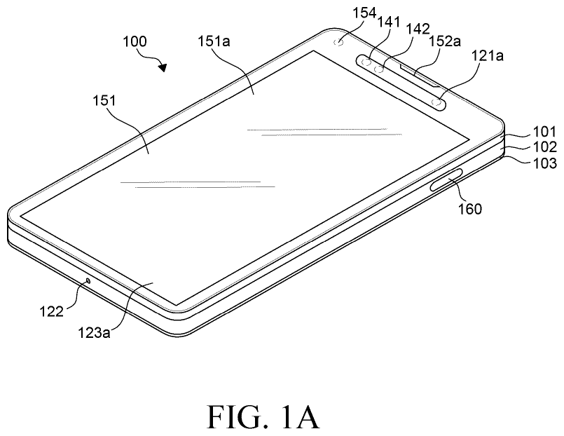

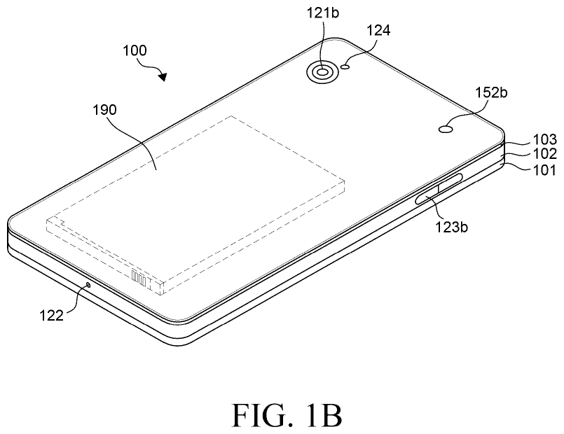

FIGS. 1A and 1B are perspective views illustrating an example of a cell phone.

FIGS. 1A and 1B are perspective views illustrating a front surface and a rear surface of a cell phone as an example of a mobile electronic device.

Referring to FIGS. 1A and 1B, the cell phone 100 may include a bar type terminal body, but the present disclosure is not limited thereto. Therefore, the cell phone may be applied to various structures, such as a watch type, a clip type, a glass type, or a folder type, a flip type, a slide type, a swing type, and a swivel type in which two or more terminal bodies are coupled to be relatively movable. Here, the terminal body may be understood as a concept referring to one cell phone 100 as at least one set.

The cell phone 100 may include a case (for example, a frame, a housing, or a cover) which forms an exterior. As illustrated in the drawing, the cell phone 100 may include a front case 101 and a rear case 102. Various electronic components may be disposed in an inner space formed by coupling the front case 101 and the rear case 102. At least one middle case may be additionally disposed between the front case 101 and the rear case 102.

A display unit 151 is disposed on a front surface of the terminal body to output information. At this time, for example, a window 151a of the display unit 151 is mounted in the front case 101 to form a front surface of the terminal body together with the front case 101.

In some cases, electronic components may be also mounted in the rear case 102. Electronic components which are mountable in the rear case 102 include a detachable battery, an identification module, and a memory card. In this case, the rear cover 103 which covers the mounted electronic components may be detachably mounted in the rear case 102. Accordingly, if the rear cover 103 is separated from the rear case 102, the electronic components mounted in the rear case 102 may be exposed to the outside.

As illustrated in the drawing, if the rear cover 103 is coupled to the rear case 102, a part of a side surface of the rear case 102 may be exposed. In some cases, when the rear cover is coupled to the rear case, the rear case 102 may be fully covered by the rear cover 103.

In the meantime, an opening which exposes a camera 121b or a sound output unit 152b to the outside may be provided on the rear cover 103.

The cases 101, 102, and 103 may be formed by injecting synthetic resins or formed of metal, such as stainless steel (STS), aluminum (Al), or titanium (Ti).

The cell phone 100 may include a display unit 151, first and second sound output units 152a and 152b, a proximity sensor 141, an illumination sensor 142, a light output unit 154, first and second cameras 121a and 121b, first and second manipulation units 123a and 123b, a micro phone 122 and/or an interface unit 160.

The display unit 151 may display (output) information processed in the cell phone 100. For example, the display unit 151 may display execution screen information of an application program driven in the cell phone 100 or user interface (UI) and graphic user interface (GUI) information in accordance with the execution screen information.

The display unit 151 may include at least one of a liquid crystal display (LCD), an organic light emitting diode (OLED), a flexible display, a three-dimensional (3D) display, and an electronic ink (e-ink) display.

Further, two or more display units 151 may be provided in accordance with an implementation type of the cell phone 100. In this case, a plurality of display units may be disposed to be spaced apart from each other or integrally disposed on one surface of the cell phone 100 or may be disposed on different surfaces.

The display unit 151 may include a touch sensor which senses touch on the display unit 151 so as to receive the control command by the touch method. Therefore, when the touch is made on the display unit 151, the touch sensor senses the touch and a controller may generate a control command corresponding to the touch based on the touch. Contents input by the touch method may be letters or numbers or instructions in various modes or menu items which may be designated.

As described above, the display unit 151 may form a touch screen together with the touch sensor and in this case, the touch screen may serve as a user input unit. In some cases, the touch screen may replace at least some function of the first manipulation unit 123a.

The first sound output unit 152a of the cell phone 100 may be implemented as a receiver which transmits a call sound to the user's ear and the second sound output unit 152b may be implemented as a loud speaker which outputs various alarm sounds or multimedia playback sounds.

In the window 151a of the display unit 151, a sound hole which releases a sound generated from the first sound output unit 152a. However, the present disclosure is not limited thereto and the sound may be configured to be released along an assembly gap between structures (for example, an interval between the window 151a and the front case 101).

The light output unit 154 is configured to output light to notify an event when the event occurs. Examples of the event may be message reception, call signal reception, missed call, alarm, schedule notification, email reception, and information reception through an application.

The first camera 121a process an image frame of a still image or a moving image obtained by an image sensor in a shooting mode or a video call mode. The processed image frame may be displayed on the display unit 151 and stored in the memory.

The first and second manipulation units 123a and 123b are an example of user input units which are manipulated to receive an instruction to control an operation of the cell phone 100. The first and second manipulation units 123a and 123b may be employed in any tactile manner which allows a user to manipulate while feeling a tactile sensation, such as touch, push, or scroll.

Further, the first and second manipulation units 123a and 123b may be also employed as a method which manipulates without a user's tactile feeling, by proximity touch or hovering touch.

The microphone 122 may be configured to receive a user's voice or other sounds. The microphone 122 is provided in a plurality of locations to receive stereo sounds.

The interface unit may be a passage which connects the cell phone 100 to external devices. For example, the interface unit may be at least one of a connection terminal for connection with other device (for example, an earphone or an external speaker), a port for near field communication (for example, an infrared port (IrDA port), a Bluetooth port, or a wireless LAN port), or a power supply terminal for supplying a power to the cell phone 100.

The second camera 121b may be disposed on the rear surface of the terminal body.

A flash 124 is disposed to be adjacent to the second camera 121b. The flash 124 flashes light toward a subject when the subject is photographed using the second camera 121b.

The second sound output unit 152b may be further disposed in the terminal body. The second sound output unit 152b may implement a stereo function together with the first sound output unit 152a and may be also used to implement a speaker phone mode while taking on the phone.

The terminal body may include a power supply unit which supplies a power to the cell phone 100. The power supply unit may be embedded in the terminal body or may include a flexible battery 190 which is configured to be detachable at the outside of the terminal body.

The flexible battery 190 may be configured to be supplied with the power through a power cable connected to the interface unit. Further, the flexible battery 190 may be configured to be wirelessly chargeable by a wireless charging device. The wireless charging may be implemented by a self-induction method or a resonance method (magnetic resonance method).

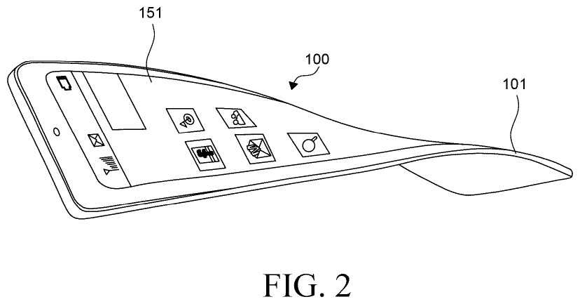

In the meantime, in FIG. 2B, the rear cover 103 is configured to be coupled to the rear case 102 so as to cover the flexible battery 190 to limit the detachment of the flexible battery 190 and protect the flexible battery 190 from external shocks and foreign materials.

When the flexible battery 190 is configured to be detachable from the terminal body, the rear cover 103 may be detachably coupled to the rear case 102.

FIG. 2 is a perspective view illustrating another example of a deformable cell phone.

Referring to FIG. 2, the display unit 151 may be configured to be deformable by an external force. The deformation may be at least one of warping, bending, folding, twisting, and rolling of the display unit 151. The deformable display unit 151 may be referred to as a “flexible display unit”. Here, the flexible display unit 151 may include all a general flexible display, an electronic paper (e-paper) and a combination thereof. The mobile electronic device of FIG. 2 may include a feature of the cell phone 100 of FIGS. 1A and 1B and similar features thereof.

In the meantime, the flexible display unit 151 is combined with a touch sensor to implement a flexible touch screen. When the touch is made on the flexible touch screen, the controller may perform control in accordance with the touch input. The flexible touch screen may be configured to sense the touch input not only in a state in which the flexible display unit 151 is not deformed (for example, a state having an infinite radius of curvature, hereinafter, referred to as a first state), but also in a state in which the flexible display unit is deformed by the external force from the first state. The latter state is a state having a finite radius of curvature and hereinafter, is referred to as a second state.

In the meantime, the cell phone according to a modified example may include a case 101 which accommodates the flexible display unit 151. The case 101 may be configured to be deformable together with the flexible display unit 151 by the external force in consideration of the characteristic of the flexible display unit 151.

The battery (not illustrated) which is provided in the cell phone may be also configured to be deformable together with the flexible display unit 151 by the external force in consideration of the characteristic of the flexible display unit 151. In order to implement the battery, a stack and folding method in which battery cells are upwardly stacked may be applied.

In the meantime, the deformation of the state of the flexible display unit 151 is not limited to the deformation by the external force. For example, when the flexible display unit 151 is in the first state, the flexible display unit may be deformed to the second state by an instruction of the user or an application.

In the meantime, the mobile electronic device may be extended to a wearable device which is wearable on a body, beyond a level of devices which are held in a user's hand to be used. The wearable device includes a smart watch, a smart glass, and a head mounted display (HMD). Hereinafter, the example of the mobile electronic device which has been extended to the wearable device will be described.

The wearable device may be configured to interchange (or interwork) data with other mobile electronic devices. The near field communication module may sense (or recognize) a communicable wearable device in the vicinity of the mobile electronic device. Moreover, if the sensed wearable device is a device which is certified to communicate with the mobile electronic device, the controller may transmit at least a part of data which is processed in the mobile electronic device to the wearable device through the near field communication module. Accordingly, the user may use the data which is processed in the mobile electronic device using the wearable device. For example, when a call is received on the mobile electronic device, it is possible to talk on the phone through the wearable device or when a message is received on the mobile electronic device, it is possible to check the received message through the wearable device.

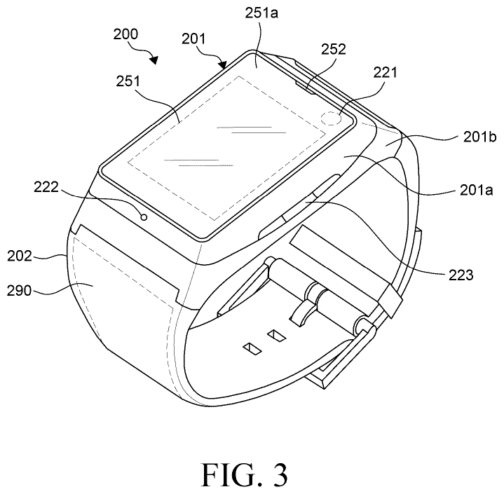

FIG. 3 is a perspective view illustrating an example of a smart watch.

Referring to FIG. 3, a watch type wearable device 200 includes a main body 201 including a display unit 251 and a band 202 which is connected to the main body 201 to be worn on a wrist. The wearable device 200 of FIG. 3 may include a feature of the cell phone 100 of FIGS. 1A and 1B and similar features thereof.

The main body 201 may include a case which forms an exterior. For example, the case may include a first case 201a and a second case 202b which provide an internal space for accommodating various electronic components.

The watch type wearable device 200 is configured to perform wireless communication and an antenna for wireless communication may be installed in the main body 201.

The display unit 251 is disposed on a front surface of the main body 201 to output information and a touch sensor is provided on the display unit 251 to be implemented as a touch screen. As illustrated in the drawing, the window 251a of the display unit 251 is mounted in the first case 201a to form a front surface of the terminal body together with the first case 201a.

The main body 201 may include a sound output unit 252, a camera 221, a micro phone 222, and a user input unit 223. In the meantime, when the display unit 251 is implemented as a touch screen, the display unit also may function as the user input unit 223 so that a separate key may not be provided in the main body 201.

The band 202 may be configured to be worn on the wrist to enclose the wrist and may be formed of a flexible material to be easily worn. As such an example, the band 202 may be formed of leather, rubber, silicon, or synthetic resin material. The band 202 is configured to be detachable from the main body 201 to be replaced with various types of bands according to the user's preference.

In the meantime, the battery 290 embedded in the band 202 may be also configured to be deformable together with the flexible band 202 by the external force in consideration of the characteristic of the flexible band 202.

In the meantime, the display device, such as the above-described mobile electronic device, is developed to be not only thin, small-sized, but also, flexible so that there is a problem in that it is not easy to apply the existing lithium-ion battery using a metal can or a rectangular battery.

Accordingly, in order to solve the structural problem as described above, a pouch type battery in which electrolyte is put into a pouch including two electrodes and a separator (or a separation film) to be sealed is used. The pouch type battery is a flexible battery which is manufactured with a material having flexibility and has advantageous to be manufactured in various forms and implement high energy density per mass.

However, if the flexible battery is repeatedly bent during the usage process, moisture or oxygen may permeate a side surface of the flexible battery due to repeated contraction and release of the exterior material and the electrode assembly, which may shorten the lifespan.

Therefore, the present disclosure provides a flexible battery which deposits the multi-layered inorganic film so as to cover a side surface of the exterior material of the flexible battery to block moisture permeation to the side surface and a display device having the same.

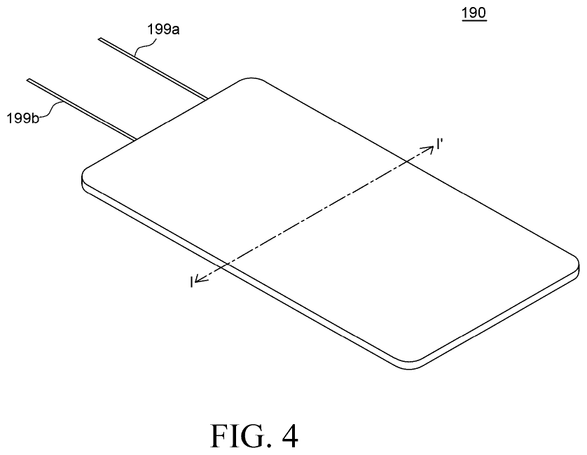

FIG. 4 is a perspective view illustrating a flexible battery of a first exemplary embodiment of the present disclosure.

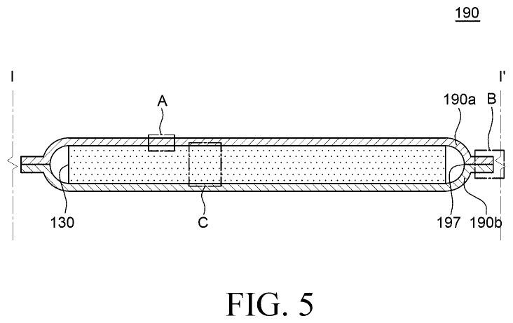

FIG. 5 is a view schematically illustrating a cross-section taken along the line I-I′ of FIG. 4.

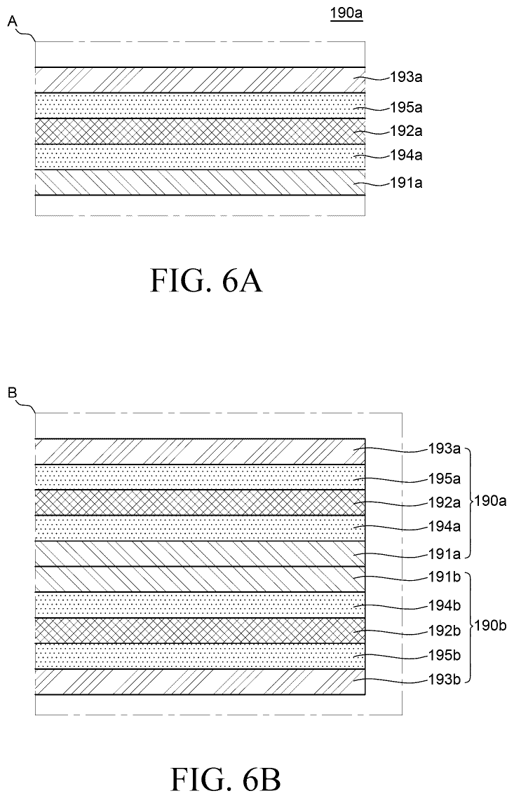

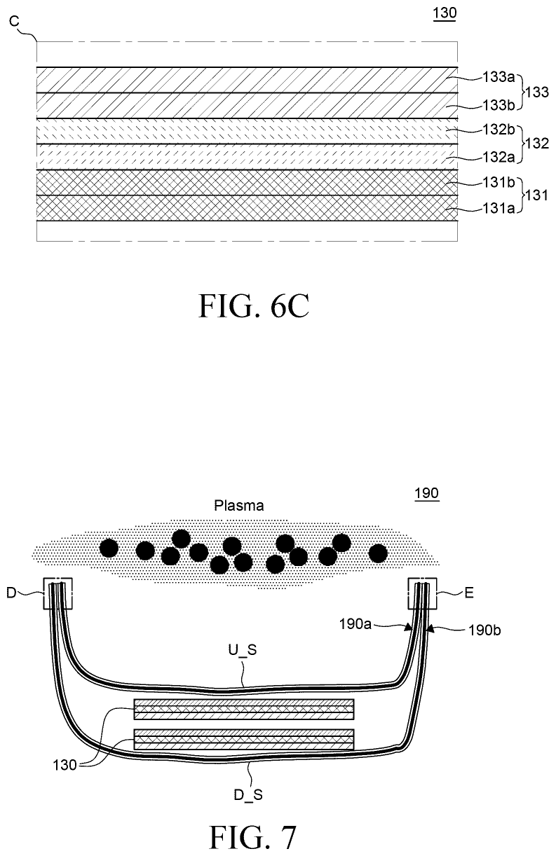

FIGS. 6A, 6B, and 6C are cross-sectional views illustrating parts A, B, and C of FIG. 5.

FIG. 6A illustrates a part of a cross-section of a first exterior material of a flexible battery of FIG. 5, FIG. 6B illustrates a part of a cross-section of an edge of a flexible battery to which first and second exterior materials are bonded, and FIG. 6C illustrates a part of a cross-section of an electrode assembly of a flexible battery.

Referring to FIGS. 4, 5, and 6A to 6C, a flexible battery 190 according to a first exemplary embodiment of the present disclosure may include an electrode assembly 130, an electrolyte, and exterior materials 190a and 190b in which the electrode assembly 130 and the electrolyte are encapsulated together.

The flexible battery 190 according to the first exemplary embodiment of the present disclosure may include a negative terminal 199a and a positive terminal 199b which electrically connect the electrode assembly 130 and the external device.

First, the exterior materials 190a and 190b will be described.

The exterior materials 190a and 190b are formed of a planar member having a predetermined area and accommodate the electrode assembly 130 and the electrolyte to protect the electrode assembly 130 from the external force.

The exterior materials 190a and 190b may include a first exterior material 190a located above the electrode assembly 130 and a second exterior material 190b located below the electrode assembly 130. At this time, “above” and “below” are based on FIG. 5.

The first exterior material 190a may include a first inner film 191a, a first barrier layer 192a, and a first outer film 193a which are sequentially laminated in one direction. Here, one direction may refer to an upward direction from the electrode assembly 130. The second exterior material 190b may include a second inner film 191b, a second barrier layer 192b, and a second outer film 193b which are sequentially laminated in the other one direction. Here, the other one direction may refer to a downward direction from the electrode assembly 130.

The first inner film 191a and the second inner film 191b are disposed inside to be in contact with the electrolyte and the first outer film 193a and the second outer film 193b may be exposed to the outside.

The first and second inner films 191a and 191b seal a space between the first exterior material 190a and the second exterior material 190b to seal so as not to allow the electrolyte provided in the flexible battery 190 to be leaked to the outside. The first and second inner films 191a and 191b may include a single layered structure of one of acid modified polypropylene (PPa), casting polypropylene (CPP), linear low density polyethylene (LLDPE), low density polyethylene (LDPE), high density polyethylene (HDPE), polyethylene, polyethylene terephthalate, polypropylene, ethylene vinyl acetate (EVA), epoxy resin, and phenol resin or a laminated structure thereof.

The barrier layers 192a and 192b are interposed between the first and second inner films 191a and 191b and the first and second outer films 193a and 193b to suppress permeation of moisture from the outside to the inside and leakage of the electrolyte from the inside to the outside.

The barrier layers 192a and 192b may have a single layered structure or a laminated structure. In the case of the single layered structure, a metal layer or a ceramic layer may be used. The metal layer may include one or more selected from aluminum, copper, phosphor bronze, aluminum bronze, cupro-nickel, beryllium copper, chromium-copper, titanium-copper, iron-copper, corson alloy, and chromium-zirconium copper alloy.

The first and second outer films 193a and 193b are located on surfaces of the first and second exterior materials 190a and 190b to reinforce the rigidity of the first and second exterior materials 190a and 190b and suppress damages, such as scratches generated on the first and second exterior materials 190a and 190b due to physical contact applied from the outside.

The first and second outer films 193a and 193b may include at least one selected from, for example, nylon, polyethylene terephthalate (PET), cyclo olefin polymer (COP), polyimide (PI), and fluorine-based compounds. Here, the fluorine-based compounds include one or more selected from polytetra fluoroethylene (PTFE), perfluorinated Acid (PFA), fluorinated ethelene propylene copolymer (FEP), polyethylene tetrafluoro ethylene (ETFE), polyvinylidene fluoride (PVDF), ethylene chlorotrifluoroethylene (ECTFE), and polychlorotrifluoroethylene (PCTFE).

A first adhesive layer 194a may be disposed between the first inner film 191a and the first barrier layer 192a and a second adhesive layer 195a may be disposed between the first barrier layer 192a and the first outer film 193a.

A third adhesive layer 194b may be disposed between the second inner film 191b and the second barrier layer 192b and a fourth adhesive layer 195b may be disposed between the second barrier layer 192b and the second outer film 193b.

The adhesive layers 194a, 195a, 194b, and 195b may serve to increase adhesion between the barrier layers 192a and 192b and the first and second inner films 191a and 191b and between the barrier layers 192a and 192b and the first and second outer films 193a and 193b. Further, the adhesive layers 194a, 195a, 194b, and 195b suppress the electrolytes accommodated in the first and second exterior materials 190a and 190b from reaching the barrier layers 192a and 192b. Therefore, corrosion of the barrier layer 192a and 192b due to acid electrolyte and separation of the barrier layers 192a and 192b and the first and second inner films 191a and 191b and the barrier layers 192a and 192b and the first and second outer films 193a and 193b may be suppressed.

Further, the adhesive layers 194a, 195a, 194b, and 195b suppress leakage of the electrolyte due to expansion of the flexible battery 190 due to problems such as abnormal over heating during the usage process of the flexible battery 190 to give the reliability for safety.

The adhesive layers 194a, 195a, 194b, and 195b may include one or more selected from silicon, polyphthalate, acid modified polypropylene (PPa), and acid modified polyethylene (Pea).

In the meantime, the first and second exterior materials 190a and 190b may include a pattern for contraction and release in a length direction during the bending.

Further, the first and second exterior materials 190a and 190b may include patterns for contraction and release in the length direction during the bending so as to match the pattern formed in the electrode assembly 130. The electrode assembly 130 and the first and second exterior materials 190a and 190b to be described below may be disposed to match both patterns.

The first and second exterior materials 190a and 190b are opposite to each other and three edges of four sides of the first and second exterior materials 190a and 190b are bonded to be manufactured as a bag.

At this time, one side surface which is not bonded is open and three edges of the first and second exterior materials 190a and 190b are bonded to prepare a space in the first and second exterior materials 190a and 190b. The electrode assembly 130, the separator, and the electrolyte are inserted into the space of the flexible battery 190.

After placing the negative terminal 199a and the positive terminal 199b of the electrode assembly 130 on one side surface of the first and second exterior materials 190a and 190b which are not bonded to be open, to be exposed, the first side surfaces are also bonded, but it is not limited thereto.

As described above, the exterior materials 190a and 190b are provided as one pair of first and second exterior materials 190a and 190b and are sealed along the edge by the thermosetting to suppress the electrolyte and the electrode assembly 130 accommodated therein from being exposed to the outside and from being leaked to the outside.

At this time, the first and second exterior materials 190a and 190b may configure a bonded portion 197 by bonding one end of the first exterior material 190a and one end of the second exterior material 190b at the edge.

The bonded portion 197 may be formed by melting the first and second inner films 191a and 191b provided in the first and second exterior materials 190a and 190b by the thermal processing of 150 degrees and then solidifying the first and second inner films 191a and 191b during the process of forming the bonded portion, but is not limited thereto. At this time, for example, the bonded portion 197 has a width of approximately 1.8 mm to be easy for permeation of moisture or oxygen.

Next, the electrode assembly 130 will be described.

The electrode assembly 130 may include a positive electrode 131, a negative electrode 133, and a separator 132 disposed between the positive electrode 131 and the negative electrode 133. The positive electrode 131 includes a positive electrode current collector 131c in which a positive electrode active materials 131a and 131b are coated on a part or all of at least one surface. The negative electrode 133 includes a foil type negative electrode current collector 133c in which negative electrode active materials 133a and 133b are coated on a part or all of at least one surface.)

As described above, the electrode assembly 130 may include a pattern for contraction or release in the length direction during the bending. The pattern suppresses or minimizes contraction or release of a base material itself by compensating for change in length caused by change in curvature in a portion bent when the flexible battery 190 is bent. By doing this, even though the bending repeatedly occurs, deformation of the base material itself which configures the electrode assembly 130 which may be locally caused in a bent portion is minimized. Therefore, the electrode assembly 130 may be suppressed from being locally damaged or degrading the performance due to the bending.

The positive electrode 131 may include a positive electrode current collector 131a and a positive electrode active material 131b and the negative electrode 133 may include a negative electrode current collector 133a and a negative electrode active material 133b.

The positive electrode current collector 131a and the negative electrode current collector 133a may be implemented by planar sheets having a predetermined area.

That is, in the positive electrode 131 and the negative electrode 133, active materials 131b and 133b are pressed, deposited, or applied on one surface or both surfaces of individual current collectors 131a and 133a, respectively. The active materials 131b and 133b may be provided in a part or all of at least one surface of the current collectors 131a and 133a.

At this time, in the positive electrode current collector 131a and the negative electrode current collector 133a, a positive terminal 199b and a negative terminal 199a for electrical connection with external devices from each body may be formed, respectively. Here, the positive terminal 199b and the negative terminal 199a extend from the positive electrode current collector 131a and the negative electrode current collector 133b to protrude from one sides of the exterior materials 190a and 190b or may be provided to be exposed on the surfaces of the exterior materials 190a and 190b.

The separator 132 disposed between the positive electrode 131 and the negative electrode 133 may include a nano fiber web layer 132a on one surface or both surfaces of a nonwoven layer 132b.

Further, when a gel-polymer electrolyte is used as the electrolyte, as the separator 132, a complex porous separator may be used to optimize an impregnation property of the gel polymer electrolyte. That is, the composite porous separator is used as a support (matrix) and may include a porous nonwoven fabric having micro pores and a porous nano fiber web formed of a radioactive molecular material and impregnated with the electrolyte.

In the meantime, even though edges of the first and second exterior materials 190a and 190b are bonded, it is difficult to completely block the moisture of the outside.

Therefore, as described above, in the flexible battery 190 of the present disclosure, a multi-layered inorganic film is formed so as to cover edges of the bonded first and second exterior materials 190a and 190b to block moisture permeation through the side surface.

Further, according to the present disclosure, edges of the bonded first and second exterior materials 190a and 190b are folded to be upwardly raised to deposit the multi-layered inorganic film to completely seal the side surface of the edge which is vulnerable to moisture permeation with a minimum of processes.

FIG. 7 is a cross-sectional view illustrating a method of depositing a multi-layered inorganic film on an edge of a flexible battery of FIG. 5 as an example.

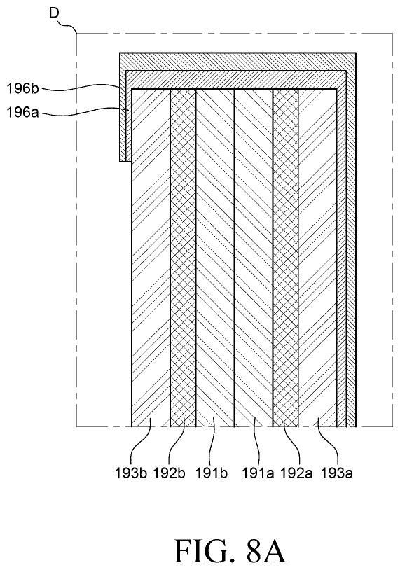

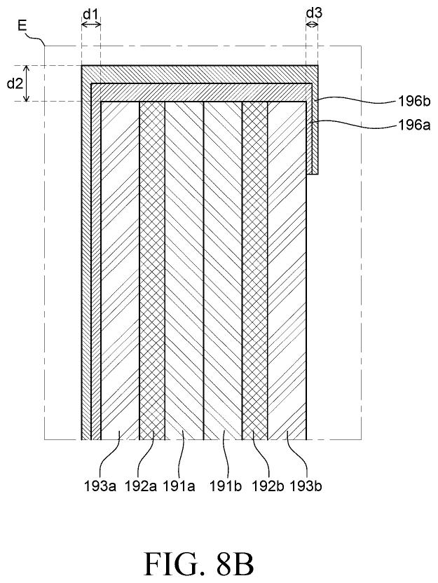

FIGS. 8A and 8B are cross-sectional views illustrating parts D and E of a flexible battery of FIG. 7 in which a multi-layered inorganic film is deposited.

FIG. 7 illustrates a method of depositing a multi-layered inorganic film in a state in which a first exterior material of the flexible battery is located in an upper portion and a second exterior material is located in a lower portion as an example.

FIGS. 8A and 8B illustrate a part of left and right edges of the flexible battery in a state in which the multi-layered inorganic film is deposited. Due to the flexible characteristic of the first and second exterior materials, after depositing the multi-layered inorganic film, as illustrated in FIG. 6, the edges of the first and second exterior materials may be restored to its original state. In FIGS. 8A and 8B, for the sake of convenience, a first adhesive layer between the first inner film and the first barrier layer, a second adhesive layer between the first barrier layer and the first outer film, a third adhesive layer between the second inner film and the second barrier layer, and a fourth adhesive layer between the second barrier layer and the second outer film are not illustrated.

Referring to FIGS. 7, 8A and 8B, in a stage both edges D and E are folded to be upwardly raised, the multi-layered inorganic films 196a and 196b are sequentially deposited on the surfaces of the bonded first and second exterior materials 190a and 190b by a chemical vapor deposition method using plasma, above the flexible battery 190.

For example, the multi-layered inorganic films 196a and 196b may be configured by sequentially placing the first inorganic film 196a and the second inorganic film 196b, but the number of multi-layered inorganic films 196a and 196b and a laminating order may freely vary.

The first inorganic film 196a may be located on a bottom layer and for example, may include one or more inorganic insulating materials, such as aluminum oxide, hafnium oxide, zinc oxide, silicon oxide, silicon nitride, titanium oxide, tantalum oxide, or silicon oxynitride. The first inorganic film 196a may be formed by a chemical vapor deposition method.

The second inorganic film 196b may be located on the first inorganic film 196a and may include one or more inorganic insulating materials, such as aluminum oxide, hafnium oxide, zinc oxide, silicon oxide, silicon nitride, titanium oxide, tantalum oxide, or silicon oxynitride. The second inorganic film 196b may be formed by a chemical vapor deposition method.

The first inorganic film 196a may be formed on the second inorganic film 196b again and the second inorganic film 196b may be formed thereon again.

As described above, the multi-layered inorganic films 196a and 196b are formed so as to cover edges including the side surfaces of the bonded first and second exterior materials 190a and 190b so that permeation of moisture, oxygen, or foreign materials to the electrode assembly 130 may be suppressed.

The edges D and E of the bonded first and second exterior materials 190a and 190b are folded to be upwardly raised to deposit the multi-layered inorganic films 196a and 196b. Therefore, the multi-layered inorganic films 196a and 196b may be deposited on a side surface to be thicker than on upper portions or lower portions of the bonded first and second exterior materials 190a and 190b.

For example, when the multi-layered inorganic films 196a and 196b may be deposited on upper surfaces of the bonded first and second exterior materials 190a and 190b with a first thickness d1, the multi-layered inorganic films 196a and 196b may be deposited on side surfaces of the bonded first and second exterior materials 190a and 190b with a second thickness d2. Further, the multi-layered inorganic films 196a and 196b may be deposited on lower surfaces of the bonded first and second exterior materials 190a and 190b with a third thickness d3.

Here, the upper surfaces of the bonded first and second exterior materials 190a and 190b refer to an upper surface of the first exterior material 190a when the first exterior material 190a of the flexible battery 190 is located in an upper portion and the second exterior material 190b is located in a lower portion to be bonded. For example, the first outer film 193a is located on a top layer so that the multi-layered inorganic films 196a and 196b may be deposited on the upper surface of the first outer film 193a with the first thickness d1.

Further, the lower surfaces D-S of the bonded first and second exterior materials 190a and 190b refer to a lower surface of the second exterior material 190b when the first exterior material 190a of the flexible battery 190 is located in an upper portion and the second exterior material 190b is located in a lower portion to be bonded. For example, the second outer film 193b is located on a bottom layer so that the multi-layered inorganic films 196a and 196b may be deposited on the lower surface of the second outer film 193b with the third thickness d3.

At this time, the plasma gas is located above the bonded first and second exterior materials 190a and 190b so that the multi-layered inorganic films 196a and 196b are deposited on the entire upper surface U-S of the bonded first and second exterior materials 190a and 190b. in contrast, the multi-layered inorganic films 196a and 196b may be deposited on only a partial surface close to the side surface, on the lower surface D-S of the bonded first and second exterior materials 190a and 190b. In the meantime, the multi-layered inorganic films 196a and 196b may be deposited in an upper portion of the bonded first and second exterior materials 190a and 190b with respect to the edge of the bonded first and second exterior materials 190a and 190b to be thicker than in the lower portion of the bonded first and second exterior materials 190a and 190b. That is, the first thickness d1 is larger than the third thickness d3. Further, the side surface of the bonded first and second exterior materials 190a and 190b is closest to the plasma gas so that the multi-layered inorganic films 196a and 196b may be deposited on the side surface of the bonded first and second exterior materials 190a and 190b to have a second thickness d2 larger than the first thickness d1.

As described above, the multi-layered inorganic films 196a and 196b may be deposited on the side surface of the bonded first and second exterior materials 190a and 190b which are vulnerable to moisture permeation with a thickness larger than the other parts. Therefore, the permeation of moisture, oxygen, or foreign materials to the electrode assembly 130 may be effectively suppressed. Therefore, the lifespan of the flexible battery 190 may be increased by three times or longer and an amount of greenhouse gas which may be generated due to a manufacturing process for producing a new flexible battery is reduced to implement environment/social/governance (ESG). For example, when the multi-layered inorganic films 196a and 196b may be configured by SiON/SINx, a water vapor transmission rate (WVTR) may be approximately 10⁻⁴ g/m²/day.

Further, a sealing part of the side surface of the bonded first and second exterior materials 190a and 190b is minimized to increase the energy density of the electrode assembly 130 due to an available space.

Further, the multi-layered inorganic films 196a and 196b are deposited by folding the edges D and E of the bonded first and second exterior materials 190a and 190b to be upwardly raised so that the deposition process may be reduced to twice at most. For example, when the deposition is performed on both edges D and E of the bonded first and second exterior materials 190a and 190b at one time, a total of one deposition process is necessary. Further, when the deposition is performed on both sides of the edges D and E of the bonded first and second exterior materials 190a and 190b, a total of two deposition processes are necessary.

When the deposition is alternately performed on the edges D and E of the bonded first and second exterior materials 190a and 190b, the deposition is performed while vertically placing a plurality of flexible batteries 190, without folding the edges D and E of the bonded first and second exterior materials 190a and 190b to be upwardly raised. Therefore, the deposition may be performed for the plurality of flexible batteries 190 at one time.

If the deposition is performed in front of the flexible battery and in the back of the flexible battery two times without folding the edges of bonded the first and second exterior materials to be upwardly raised, only a part of the side surface is deposited so that a total of four depositions are necessary due to the additional deposition on the side surface.

In the meantime, instead of depositing the multi-layered inorganic film on the side surface of the edges of the bonded first and second exterior materials, both configurations of the first and second exterior materials of the bonded portion are welded together to form a single structure. This will be described in detail with reference to the following second exemplary embodiment of the present disclosure.

For reference, welding refers to the process of bonding two objects by heating them to a high temperature. This method melts the surfaces of the materials and then bonds them using heat and pressure, and may be used primarily to bond materials such as metals, plastics, and fibers.

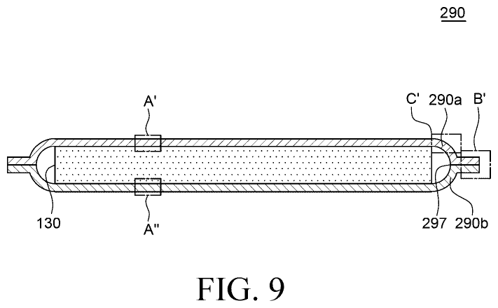

FIG. 9 is a cross-sectional view illustrating a flexible battery of a second exemplary embodiment of the present disclosure.

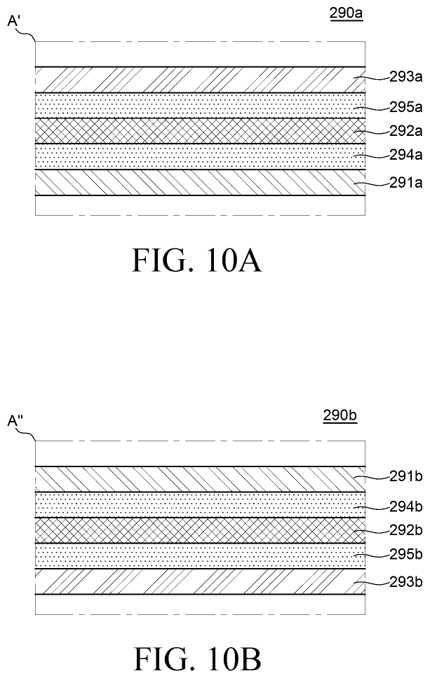

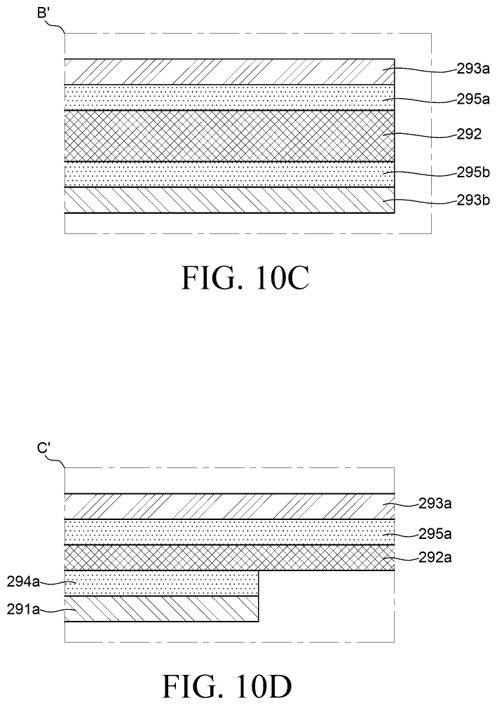

FIGS. 10A to 10D are cross-sectional views illustrating parts A′, A″, B′, and C′ of FIG. 9, respectively, as an example.

FIGS. 10A and 10B illustrate a part of a cross-section of a first exterior material and a second exterior material of a flexible battery of FIG. 9. FIG. 10C illustrates a part of a cross-section of an edge of the flexible battery in which the first and second exterior materials are bonded. FIG. 10D illustrates a part of a cross-section of the first exterior material in a vicinity of a bonded portion to which the first and second exterior materials are bonded as an example.

A flexible battery according to a second exemplary embodiment of the present disclosure FIGS. 9 and 10A to 10D is different from the first exemplary embodiment of FIGS. 4 to 7 in that both configurations of first and second exterior materials of a bonded portion are welded to be unified instead of depositing a multi-layered inorganic film on a side surface of edges of bonded first and second exterior materials. However, other configurations are substantially the same so that a redundant description will be omitted. The same configuration will be denoted with the same reference numeral. Here, the description for the same configuration may refer to FIGS. 4 to 7.

Referring to FIGS. 9 and 10A to 10d, a flexible battery 290 according to a second exemplary embodiment of the present disclosure may include an electrode assembly 130, an electrolyte, and exterior materials 290a and 290b.

The exterior materials 290a and 290b may include a first exterior material 290a located above the electrode assembly 130 and a second exterior material 190b located below the electrode assembly 130. At this time, “above” and “below” are based on FIG. 9.

The first exterior material 290a may include a first inner film 291a, a first barrier layer 292a, and a first outer film 293a which are sequentially laminated in one direction. Here, one direction may refer to an upward direction from the electrode assembly 130. The second exterior material 290b may include a second inner film 291b, a second barrier layer 292b, and a second outer film 293b which are sequentially laminated in the other one direction. Here, the other one direction may refer to a downward direction from the electrode assembly 130.

The first inner film 291a and the second inner film 291b are disposed inside to be in contact with the electrolyte and the first outer film 293a and the second outer film 293b may be exposed to the outside.

A first adhesive layer 294a may be disposed between the first inner film 291a and the first barrier layer 292a and a second adhesive layer 295a may be disposed between the first barrier layer 292a and the first outer film 293a.

A third adhesive layer 294b may be disposed between the second inner film 291b and the second barrier layer 292b and a fourth adhesive layer 295b may be disposed between the second barrier layer 292b and the second outer film 293b.

In the meantime, the first and second exterior materials 290a and 290b may include a pattern for contraction and release in a length direction during the bending.

Further, the first and second exterior materials 290a and 290b may include patterns for contraction and release in the length direction during the bending so as to match the pattern formed in the electrode assembly 130. The electrode assembly 130 and the first and second exterior materials 290a and 290b to be described below may be disposed to match both patterns.

In the meantime, the first inner film 291a and the second inner film 291b and the first and third adhesive layers 294a and 294b according to the second exemplary embodiment of the present disclosure have a size smaller than the other configurations of the first and second exterior materials 290a and 290b. The other configurations of the first and second exterior materials 290a and 290b include the first and second barrier layers 292a and 292b, the second and fourth adhesive layers 295a and 295b, and the first and second outer films 293a and 293b. For example, referring to FIG. 10D, it is understood that the first inner film 291a and the second inner film 291b and the first and third adhesive layers 294a and 294b according to the second exemplary embodiment of the present disclosure have a width smaller than the first and second barrier layers 292a and 292b, the second and fourth adhesive layers 295a and 295b, and the first and second outer films 293a and 293b. Therefore, it is also understood that in the bonded portion 297 to which the first and second exterior materials 290a and 290b are bonded, the first inner film 291a and the second inner film 291b and the first and third adhesive layers 294a and 294b are removed.

Further, in the bonded portion 297 according to the second exemplary embodiment of the present disclosure, the first barrier layer 292a and the second barrier layer 292b are welded to configure one barrier layer 292. For example, the first barrier layer 292a and the second barrier layer 292b are welded by the laser and the first barrier layer 292a and the second barrier layer 292b are welded to configure one barrier layer 292 so that the permeation of moisture or oxygen to the side surface may be blocked.

At this time, the first and second barrier layers 292a and 292b according to the second exemplary embodiment of the present disclosure may use a metal layer as a single layer structure. The metal layer may include one or more selected from aluminum, copper, phosphor bronze, aluminum bronze, cupro-nickel, beryllium copper, chromium-copper, titanium-copper, iron-copper, corson alloy, and chromium-zirconium copper alloy.

In the meantime, deposition of the multi-layered inorganic film on the side surface of the edges of the bonded first and second exterior materials may be performed after welding both first and second exterior materials of the bonded portion to form a single structure. This will be described in detail with reference to the following third exemplary embodiment of the present disclosure.

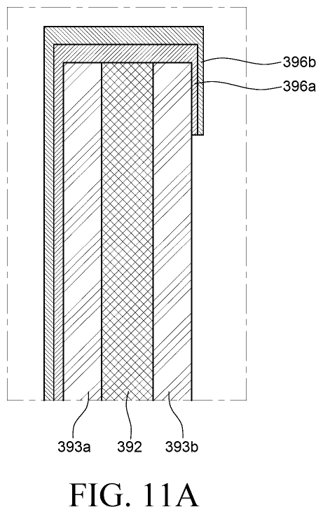

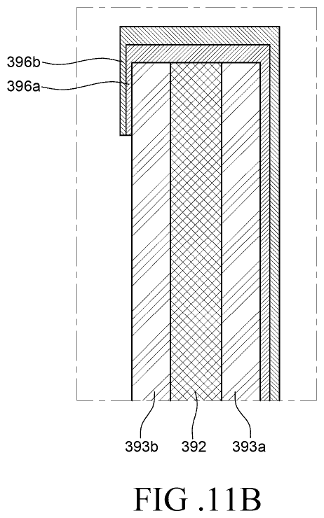

FIGS. 11A and 11B are cross-sectional views illustrating an edge of a flexible battery according to a third exemplary embodiment of the present disclosure as an example.

FIGS. 11A and 11B illustrate a part of left and right edges of the flexible battery in a state in which the multi-layered inorganic film is deposited. Due to the flexible characteristic of the first and second exterior materials, after depositing the multi-layered inorganic film, the edges of the first and second exterior materials may be restored to its original state. Further, for the sake of convenience, in FIGS. 11A and 11B, a second adhesive layer between a barrier layer and a first outer film and a fourth adhesive layer between a barrier layer and a second outer film are not illustrated.

A flexible battery according to a third exemplary embodiment of the present disclosure of FIGS. 11A and 11B is different from the above-described second exemplary embodiment of FIGS. 9 and 10A to 10D in that a multi-layered inorganic film is additionally deposited on side surfaces of edges of bonded first and second exterior materials after welding both configurations of the first and second exterior materials of the bonded portion to form a single structure. However, the other configurations are substantially the same so that a redundant description will be omitted. The same configuration will be denoted with the same reference numeral. Here, the description for the same configuration may refer to FIGS. 4 to 10D.

Referring to FIGS. 11A and 11B, in a bonded portion of a third exemplary embodiment of the present disclosure, a first barrier layer of a first exterior material and a second barrier layer of a second exterior material are welded to configure one barrier layer 392. For example, the first barrier layer and the second barrier layer are welded by the laser and the first barrier layer and the second barrier layer are welded to configure one barrier layer 392 so that the permeation of moisture or oxygen to the side surface may be blocked.

Similar to the second exemplary embodiment of the present disclosure described above, the first and second barrier layers according to the third exemplary embodiment of the present disclosure may use a metal layer as a single layer structure. The metal layer may include one or more selected from aluminum, copper, phosphor bronze, aluminum bronze, cupro-nickel, beryllium copper, chromium-copper, titanium-copper, iron-copper, corson alloy, and chromium-zirconium copper alloy

In the third exemplary embodiment of the present disclosure, in the bonded portion in which one end of the first exterior material and one end of the second exterior material are bonded, the first outer film 393a, the barrier layer 392, and the second outer film 393b may be sequentially disposed.

In the meantime, in the case of the third exemplary embodiment of the present disclosure, the first and second barrier layers of the first and second exterior materials of the bonded portion are welded to be unified as one barrier layer 392. Thereafter, the multi-layered inorganic films 396a and 396b are deposited on the side surfaces of the edges of the bonded first and second exterior materials.

For example, in a state in which both edges of the bonded first and second exterior materials are folded to be upwardly raised, the multi-layered inorganic films 396a and 396b are sequentially deposited on surfaces of the bonded first and second exterior materials by a chemical vapor deposition method using plasma above the flexible battery.

For example, the multi-layered inorganic films 396a and 396b may be configured by sequentially placing the first inorganic film 396a and the second inorganic film 396b, but the number of multi-layered inorganic films 396a and 396b and a laminating order may freely vary.

The first inorganic film 396a may be formed on the second inorganic film 396b again and the second inorganic film 396b may be formed thereon again.

As described above, the multi-layered inorganic films 396a and 396b are formed so as to cover edges including the side surfaces of the bonded first and second exterior materials so that permeation of moisture, oxygen, or foreign materials to the electrode assembly may be additionally suppressed.

In the same way as the first exemplary embodiment of the present disclosure as described above, the edges of the bonded first and second exterior materials are folded to be upwardly raised to deposit the multi-layered inorganic films 396a and 396b. Therefore, the multi-layered inorganic films 396a and 396b may be deposited on a side surface thicker than upper and lower portions of the bonded first and second exterior materials.

Further, the multi-layered inorganic films 396a and 396b are deposited on the entire upper surface of the bonded first and second exterior materials, but the multi-layered inorganic films 396a and 396b may be deposited only in a part of a surface close to the side surface, on the lower surface of the bonded first and second exterior materials. In the meantime, the multi-layered inorganic films 396a and 396b may be deposited with a thickness in an upper portion of the bonded first and second exterior materials with respect to the edge of the bonded first and second exterior materials larger than in a lower portion of the bonded first and second exterior materials.

As described above, after welding the first and second barriers of the first and second exterior materials of the bonded portion which is vulnerable to the moisture permeation to be unified as one barrier layer 392, the multi-layered inorganic films 396a and 396b is deposited on the side surface of the edge of the bonded first and second exterior materials with a thickness larger than the other part. Accordingly, the permeation of moisture, oxygen, or foreign materials to the electrode assembly may be further effectively suppressed.

The exemplary embodiments of the present disclosure can also be described as follows:

According to an aspect of the present disclosure, there is provided a flexible battery. The flexible battery includes an electrode assembly, a first exterior material and a second exterior material bonded at edges and encapsulate the electrode assembly above and below the electrode assembly and a multi-layered inorganic film which is deposited on exterior surfaces of the bonded first and second exterior materials, a thickness of the multi-layered inorganic film on a side surface of the bonded first and second exterior materials may be greater than a thickness in the upper portion and the lower portion.

The electrode assembly may include a positive electrode including a positive electrode current collector having at least a portion of one surface coated with a positive electrode active material, a negative electrode including a negative electrode current collector having at least a portion of one surface coated with a negative electrode active material and a separator disposed between the positive electrode and the negative electrode.

The first exterior material may include a first inner film, a first barrier layer, and a first outer film which are sequentially laminated in one direction and the second exterior material may include a second inner film, a second barrier layer, and a second outer film which are sequentially laminated in the other one direction.

The flexible battery may further comprise an electrolyte accommodated in the bonded first and second exterior materials, the first inner film and the second inner film may be disposed inside to be in contact with the electrolyte and the first outer film and the second outer film may be exposed to the outside.

The first barrier layer and the second barrier layer may have a single layer structure or a laminated structure.

In the case of the single layer structure, a metal layer or a ceramic layer may be included and the metal layer may include one or more materials selected from aluminum, copper, phosphor bronze, aluminum bronze, cupro-nickel, beryllium copper, chromium-copper, titanium-copper, iron-copper, corson alloy, and chromium-zirconium copper alloy.

The flexible battery may further comprise a first adhesive layer disposed between the first inner film and the first barrier layer, a second adhesive layer disposed between the first barrier layer and the first outer film, a third adhesive layer disposed between the second inner film and the second barrier layer and a fourth adhesive layer disposed between the second barrier layer and the second outer film.

The multi-layered inorganic film may be deposited in a state in which the edges of the bonded first and second exterior materials are folded to be upwardly raised.

One end of the first exterior material and one end of the second exterior material may be bonded in the edges of the bonded first and second exterior materials to configure a bonded portion.

In the multi-layered inorganic film, a first inorganic film and a second inorganic film may be sequentially disposed and the first inorganic film and the second inorganic film may include one or more selected materials from aluminum oxide, hafnium oxide, zinc oxide, silicon oxide, silicon nitride, titanium oxide, tantalum oxide, and silicon oxynitride.

The multi-layered inorganic film may be deposited on an entire upper surface of the bonded first and second exterior materials and the multi-layered inorganic film may be deposited on only a part of the surface close to the side surface, on the lower surface of the bonded first and second exterior materials.

The multi-layered inorganic film may be deposited above the bonded first and second exterior materials to be thicker than below the bonded first and second exterior materials.

The first and second inner films and the first and third adhesive layers may have widths smaller than that of the first and second barrier layers, the second and fourth adhesive layers, and the first and second outer films.

In the bonded portion, the first and second inner films and the first and third adhesive layers may be removed.

In the bonded portion, the first and second barrier layers may be welded to configure one barrier layer.

According to another aspect of the present disclosure, there is provided a flexible battery. The flexible battery includes an electrode assembly and a first exterior material and a second exterior material which seal the electrode assembly above and below the electrode assembly and bond one ends at the edge to configure a bonded portion, the first exterior material may include a first inner film, a first barrier layer, and a first outer film, the second exterior material may include a second inner film, a second barrier layer, and a second outer film, and in the bonded portion, single barrier layer configured by the first and second barrier layers may be disposed.

The flexible battery may further comprise a first adhesive layer disposed between the first inner film and the first barrier layer, a second adhesive layer disposed between the first barrier layer and the first outer film, a third adhesive layer disposed between the second inner film and the second barrier layer and a fourth adhesive layer disposed between the second barrier layer and the second outer film.

The first and second inner films and the first and third adhesive layers may have widths smaller than that of the first and second barrier layers, the second and fourth adhesive layers, and the first and second outer films.

In the bonded portion, the first exterior material may be configured by the first barrier layer and the first outer film and the second exterior material may be configured by the second barrier layer and the second outer film, and in the bonded portion, the second adhesive layer may be disposed between the first barrier layer and the first outer film and the fourth adhesive layer may be disposed between the second barrier layer and the second outer film.

According to still another aspect of the present disclosure, there is provided a display device. The display device includes the the above-described flexible battery.

It will be apparent to those skilled in the art that various modifications and variations can be made in the flexible battery and the display device having the same of the present disclosure without departing from the technical idea or scope of the disclosure. Thus, it is intended that the present disclosure cover the modifications and variations of this disclosure provided they come within the scope of the appended claims and their equivalents.

What is claimed is:

1. A flexible battery, comprising:
an electrode assembly;
a first exterior material and a second exterior material bonded at edges and encapsulate the electrode assembly above and below the electrode assembly; and
a multi-layered inorganic film which is deposited on exterior surfaces of the bonded first and second exterior materials,
wherein a thickness of the multi-layered inorganic film on a side surface of the bonded first and second exterior materials is greater than a thickness in the upper portion and the lower portion.

2. The flexible battery according to claim 1, wherein the electrode assembly includes:
a positive electrode including a positive electrode current collector having at least a portion of one surface coated with a positive electrode active material;
a negative electrode including a negative electrode current collector having at least a portion of one surface coated with a negative electrode active material; and
a separator disposed between the positive electrode and the negative electrode.

3. The flexible battery according to claim 1, wherein the first exterior material includes a first inner film, a first barrier layer, and a first outer film which are sequentially laminated in one direction and the second exterior material includes a second inner film, a second barrier layer, and a second outer film which are sequentially laminated in the other one direction.

4. The flexible battery according to claim 3, further comprising:
an electrolyte accommodated in the bonded first and second exterior materials,
wherein the first inner film and the second inner film are disposed inside to be in contact with the electrolyte and the first outer film and the second outer film are exposed to the outside.

5. The flexible battery according to claim 3, wherein the first barrier layer and the second barrier layer have a single layer structure or a laminated structure.

6. The flexible battery according to claim 5, wherein the first barrier layer and the second barrier layer have a single layer structure, and
wherein a metal layer or a ceramic layer is included and the metal layer includes one or more selected materials from aluminum, copper, phosphor bronze, aluminum bronze, cupro-nickel, beryllium copper, chromium-copper, titanium-copper, iron-copper, corson alloy, and chromium-zirconium copper alloy.

7. The flexible battery according to claim 3, further comprising:
a first adhesive layer disposed between the first inner film and the first barrier layer;
a second adhesive layer disposed between the first barrier layer and the first outer film;
a third adhesive layer disposed between the second inner film and the second barrier layer; and
a fourth adhesive layer disposed between the second barrier layer and the second outer film.

8. The flexible battery according to claim 1, wherein the multi-layered inorganic film is deposited in a state in which the edges of the bonded first and second exterior materials are folded to be upwardly raised.

9. The flexible battery according to claim 7, wherein one end of the first exterior material and one end of the second exterior material are bonded in the edges of the bonded first and second exterior materials to configure a bonded portion.

10. The flexible battery according to claim 1, wherein in the multi-layered inorganic film, a first inorganic film and a second inorganic film are sequentially disposed and the first inorganic film and the second inorganic film include one or more selected materials from aluminum oxide, hafnium oxide, zinc oxide, silicon oxide, silicon nitride, titanium oxide, tantalum oxide, and silicon oxynitride.

11. The flexible battery according to claim 1, wherein the multi-layered inorganic film is deposited on an entire upper surface of the bonded first and second exterior materials and the multi-layered inorganic film is deposited on only a part of the surface close to the side surface, on the lower surface of the bonded first and second exterior materials.

12. The flexible battery according to claim 1, wherein the multi-layered inorganic film is deposited above the bonded first and second exterior materials to be thicker than below the bonded first and second exterior materials.

13. The flexible battery according to claim 9, wherein the first and second inner films and the first and third adhesive layers have widths smaller than that of the first and second barrier layers, the second and fourth adhesive layers, and the first and second outer films.

14. The flexible battery according to claim 13, wherein in the bonded portion, the first and second inner films and the first and third adhesive layers are removed.

15. The flexible battery according to claim 14, wherein in the bonded portion, the first and second barrier layers are welded to configure one barrier layer.

16. A flexible battery, comprising:
an electrode assembly; and
a first exterior material and a second exterior material which seal the electrode assembly above and below the electrode assembly and bond one ends at the edge to configure a bonded portion,
wherein the first exterior material includes a first inner film, a first barrier layer, and a first outer film, the second exterior material includes a second inner film, a second barrier layer, and a second outer film, and in the bonded portion, single barrier layer configured by the first and second barrier layers is disposed.

17. The flexible battery according to claim 16, further comprising:
a first adhesive layer disposed between the first inner film and the first barrier layer;
a second adhesive layer disposed between the first barrier layer and the first outer film;
a third adhesive layer disposed between the second inner film and the second barrier layer; and
a fourth adhesive layer disposed between the second barrier layer and the second outer film.

18. The flexible battery according to claim 17, wherein the first and second inner films and the first and third adhesive layers have widths smaller than that of the first and second barrier layers, the second and fourth adhesive layers, and the first and second outer films.

19. The flexible battery according to claim 18, wherein in the bonded portion, the first exterior material is configured by the first barrier layer and the first outer film and the second exterior material is configured by the second barrier layer and the second outer film, and in the bonded portion, the second adhesive layer is disposed between the first barrier layer and the first outer film and the fourth adhesive layer is disposed between the second barrier layer and the second outer film.

20. A display device comprising the flexible battery according to claim 1.
